(19) United States
(12) Patent Application Publication
(10) Pub. No.: US 2024/0068296 A1
(43) Pub. Date: Feb. 29, 2024

(54) FIRE-RETARDANT CORES FOR HOLLOW-CORE DOORS

(71) Applicant: Timber Products Co. Limited Partnership, Springfield, OR (US)

(72) Inventor: David REED, Eugene, OR (US)

(21) Appl. No.: 18/454,714

(22) Filed: Aug. 23, 2023

Related U.S. Application Data
(60) Provisional application No. 63/373,312, filed on Aug. 23, 2022.

(51) Int. Cl. E06B 5/16

(52) U.S. Cl. CPC E06B 5/16

(57) ABSTRACT

A fire-retardant core for a door with a central cavity includes a first solid component made from non-fibrous material that is effective to disperse solid particles and to reduce water solubility. The core also includes a second solid component made from fibrous material that is less dense than the first component, and is effective to fill volume in the central cavity. The core also includes a third component made from a fire retardant material that tends to prevent combustion. The first, second and third components are blended effectively to fill the central cavity, and to provide a fire-retardant quality to the door.

### CROSS-REFERENCE TO RELATED APPLICATIONS

This application claims priority to U.S. Provisional Patent Application Ser. No. 63/373,312, filed Aug. 23, 2022 and entitled FIRE-RETARDANT CORES FOR HOLLOW-CORE DOORS, the disclosure of which is incorporated herein by reference.

### SUMMARY OF THE INVENTION

The inventions involve fire-retardant cores for hollow-core doors, and a process for making those fire-retardant cores.

### DETAILED DESCRIPTION

The following are features of the inventions, and for each component, commercially suitable versions of those components are used.
a. Materials are used to deliver fire retardant feature at reduced weight and cost;
b. The solid components that make the fire-retardant feature (i. below) are blended using commercially suitable techniques, and then mixed with other particles (ii. below) that will be form the outer structure of the door. These processing steps concentrate the nanomaterial with other components that provides increase the effectiveness of the fire-retardant feature:
i. Materials for fire-retardant feature:
   1. Boron;
   2. vermiculite (clay) which adds undesired weight but required to disperse the boron and reduce its water solubility; and
   3. nanofibers to blend with the vermiculite and boron/borate; and
ii. Materials for outer structure of door:
   1. Saw dust (filler);
   2. resin (binder); and
   3. waxes (retards moisture absorption).

What is claimed:

1. A fire-retardant core for a door formed with a central cavity, comprising:
a first solid component made from non-fibrous material that is effective to disperse solid particles and to reduce water solubility;
a second solid component made from fibrous material that is less dense than the first component, and is effective to fill volume in the central cavity;
a third component made from a fire retardant material that tends to prevent combustion; and
wherein the first, second and third components are blended effectively to fill the central cavity, and to provide a fire-retardant quality to the door.

2. The core of claim 1, wherein the first solid component includes clay.

3. The core of claim 2, wherein the first solid component includes vermiculite.

4. The core of claim 1, wherein the second solid component includes nanofibers.

5. The core of claim 1, wherein the third component includes boron.

6. The core of claim 5, wherein the boron is in the form of borate.

7. The core of claim 6, wherein the borate is chosen from the group consisting of zinc borate and sodium borate.
